(19) United States
(12) Patent Application Publication
(10) Pub. No.: US 2008/0040702 A1
(43) Pub. Date: Feb. 14, 2008

(54) Nonlinear workflow assembly for visual programming

(75) Inventors: David Sciacero, Burlingame, CA (US); Stephen Asbury, Pasedena, CA (US)

Correspondence Address: BAKER & MCKENZIE LLP;PATENT DEPARTMENT, 2001 ROSS AVENUE, SUITE 2300, DALLAS, TX, 75201, US

(73) Assignee: TIBCO Software Inc., Palo Alto, CA (US)

(21) Appl. No.: 11/697,501

(22) Filed: Apr. 6, 2007

Related U.S. Application Data
(60) Provisional application No. 60/744,588, filed on Apr. 10, 2006.

(51) Int. Cl. G06F 9/44; G06F 3/048

(52) U.S. Cl. 717/100; 717/105; 717/113; 715/764; 715/781

(57) ABSTRACT

Disclosed herein are embodiments of a nonlinear workflow assembly environment for visual programming providing a method for enabling a user to design computer processes. The multidimensional design environment provides mechanisms for branching, conditionals, and other dimensional functionality. A preferred embodiment provides a multidimensional design environment particularly suited for designing automated business processes.

### RELATED APPLICATION

This application claims priority to U.S. provisional patent application No. 60/744,588 filed on Apr. 10, 2006. The disclosure of application No. 60/744,588 is incorporated herein by reference in its entirety.

### TECHNICAL FIELD

The present disclosure generally relates to computer process design tools and more specifically relates to methods for providing a multidimensional design environment for visual programming languages.

### BACKGROUND

Visual programming languages provide computer process designers with the ability to create computer processes by manipulating process elements graphically rather than requiring the designers to actually write lines of computer code. This simplification makes designing computer processes easier, more reliable, and more accessible for process designers who are not necessarily trained computer programmers or software engineers.

In a typical design environment for a visual programming language, a user designs a computer process by selecting various icons representing process components and connecting the icons with arrows. Problems arise as the processes become more complex, because the resulting flow charts are not rich enough to capture all possible contingencies when large or complex processes are represented. When trying to edit a process using a flow chart, a user must click on the flow chart components, or icons. This typically sends the user to another screen with a form used for configuration of the component, resulting in a loss of context. A new design environment is needed to support multiple dimensions of activity and to display flow criteria and dimensions in a consistent and approachable way, obviating the need for complex flow diagrams with highly complex interactions, and instead providing a simple interface for achieving the same results with simple interactions.

### BRIEF SUMMARY

Disclosed herein are embodiments of a nonlinear workflow assembly environment for visual programming providing a method for enabling a user to design computer processes. The multidimensional design environment provides mechanisms for branching, conditionals, and other dimensional functionality. A preferred embodiment provides a multidimensional design environment particularly suited for designing automated business processes.

### BRIEF DESCRIPTION OF THE DRAWINGS

FIG. 1 is an exemplary screen display of a graphical user interface in a multidimensional design environment for visual programming.

### DETAILED DESCRIPTION

Various aspects of a method enabling a user to design computer processes using a nonlinear workflow assembly environment for visual programming according to the present disclosure are described. It is to be understood, however, that the following explanation is merely exemplary in describing aspects of the present disclosure. Accordingly, several modifications, changes, and substitutions are contemplated.

The Nonlinear Workflow Assembly relates to creating a multidimensional design environment for visual programming languages, with mechanisms provided for branching, conditionals, and other dimensional functionality. Some embodiments are particularly suited for providing a multidimensional design environment for designing automated business processes. The visual programming environment supports multiple dimensions of action. For example, a single element in a program may result in different directions of flow based on different criteria. These criteria and dimensions are displayed in a consistent and approachable way, providing a simple interface with simple interactions.

The Nonlinear Workflow Assembly is built on several core concepts. First, a process, or program in the general case, is constructed from activities. An activity represents a unit of work. Each activity can require configuration information, or settings, to define exactly what work it will do. Activities can also accept input and return output. For example, an activity may invoke a web service. The configuration for such an Invoke activity would include information about the web service to invoke. The input would be the input required by the web service and the output would be the output returned by the web service, and possibly information about an error.

Activities at runtime can be executed, invoked or run to do work. In the Invoke activity example above, the Invoke activity is executed to actually send data to the web service and retrieve the results.

Each activity in the Nonlinear Workflow Assembly is represented as a configuration area. This configuration area provides the user interface elements necessary to configure the activity. By displaying activities as their configuration, an understandable visual pattern is provided.

Activities are combined into a process, or program. The language underlying the editor will determine how this initial combination is defined as well as what activities will be available to the user. In the specific case of a Business Process Execution Language (BPEL), the program is defined by an initial “main” activity and that activity's configuration defines the entirety of the program.

The Nonlinear Workflow Assembly displays a process, or program, as a series of columns. Each column is defined by an activity, and in some embodiments a single activity may define multiple columns. Each column is resizable and scrollable.

This column structure is extremely flexible. Because the editor can scroll horizontally to show as many columns as necessary, a very small area can be used to display a very deep hierarchy. The column “browser” shows depth while maintaining context.

Activities can contain sub-activities referred to as child activities. Child activities of a parent activity define a type of program flow. For example, a Sequence activity may contain one or more child activities. When the Sequence activity is run it will run its child activities in order.

Child activities are displayed in the Nonlinear Workflow Assembly as a column to the right. For example, when the Sequence activity is selected, a new column is displayed to the right of the Sequence activity. This column will contain the Sequence activity's child activities, in order, as a list of their configuration interfaces.

By allowing the parent activity to define the column for its child activities, the Nonlinear Workflow Assembly provides immense flexibility. For example, a Sequence activity can be displayed as a list while a Flow activity can be displayed as an embedded diagram. Other activities can display arbitrary user interface patterns to define their child activities.

One specific design feature of the Nonlinear Workflow Assembly is the ability to provide multiple sets of child activities. While the Sequence activity above has one set of child activities, a Scope activity might have several sets of child activities based on different flow criteria. For example, a Scope activity might have a Main child activity and an Error child Activity. One is run under normal conditions and the other under error conditions.

In general, sets of child activities are displayed as areas in a column. For example, in this embodiment, when the Scope activity is selected it will display a column to the right with two areas, one labeled “Main” and one labeled “Error.”

In a preferred embodiment, the Nonlinear Workflow Assembly is a columned browser that displays grouped lists of activities. Each activity defines the interface used for defining the activity's configuration and the activity's child activities. Because the columned user interface provides a solid base structure, the interface is easy to use and improves the user's ability to manage complexity in large programs. With the columned browser approach of the Nonlinear Workflow Assembly, the user can edit and construct processes at the same time. The complex and advanced editors of the Nonlinear Workflow Assembly are one reason why this is possible. These editors absorb much of the complexity involved in constructing advanced processes, allowing the user to develop much more complex processes than was previously practical. The Nonlinear Workflow Assembly takes the form and actually makes it part of the picture. It provides an editor specifically designed for the activity that the user is trying to configure, and preserves the context to enable the user to continue to see the larger picture of what is happening in the process. For certain activities, a picture or flow chart is the best and most practical way to represent the activity. Consequently the Nonlinear Workflow Assembly will still provide such a representation. But for complex activities, when a picture or flow chart may be insufficient, the “nonlinear” aspect of the invention allows for better visualization of the process and associated activities. With the Nonlinear Workflow Assembly, the configuration of the activity is brought right along with the construction of the activity, allowing the user to see both the activity and the configuration in a very manageable user interface that does not take up an unmanageable amount of space and is easy for the user to navigate. With the columned browser approach, the user can browse to the left to see parent activities and browse to the right to see child activities. The editors supply the appropriate forms for the selected activity.

The Nonlinear Workflow Assembly provides an environment that allows a user not necessarily trained in programming techniques to design complex processes. The Nonlinear Workflow Assembly provides a visual programming environment with complex and tailored editors to guide the user through the development process. The Nonlinear Workflow Assembly allows the user to see more of the development process, while protecting the user from getting bogged down in unnecessary complexity. The described embodiments allow handling process design tasks that are so complex that they are difficult to address with conventional diagrams. These embodiments comprise a usable editor for these types of situations.

The Nonlinear Workflow Assembly visually connects activities in at least two ways. Activities are visually connected to forms and are visually connected to columns. When a user begins a new development project, the initial columns are provided, after which all activities are put into a parent column. These activities are connected to a form and also to a column because parent activities manage their child activities. The editors control what types of child activities a parent activity can have and also what types of child activities a parent activity must have. This relieves the user of having to know the underlying structure in advance because the editors provide the structure and guide the user in a very straightforward and consistent manner.

For example, clicking on a Flow activity invokes the Flow editor. Flow and its siblings appear on the left, while the child activities of Flow appear on the right. The user can add, subtract, or modify the child activities of Flow within the constraints imposed by the Flow editor. Clicking on a Throw activity might result in a very different configuration on the right, because the Throw editor will restrict the user to only the configuration allowed for Throw. In this way, by clicking on the sibling of a particular activity, the user is able to control how much complexity is presented. The user can see the other activities, but is not forced to, as in the case of conventional diagrams.

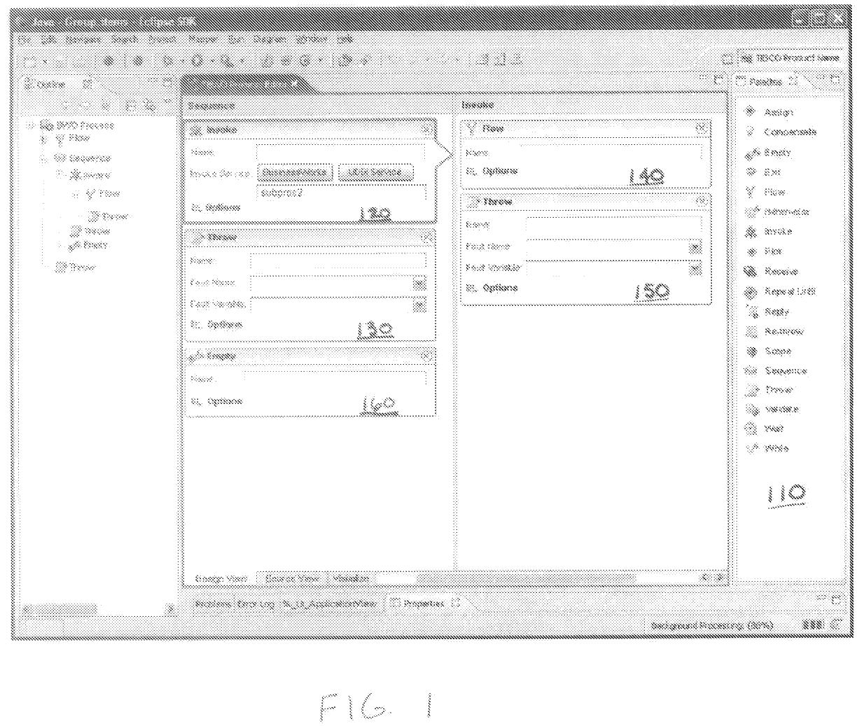

In FIG. 1, an exemplary embodiment of a graphical user interface is displayed on a computer display screen. When a computer process designer selects an activity from menu 110, for example, a Throw activity, configuration form 130 is displayed. The user is able to configure the selected activity by filling out configuration form 130. An editor associated with configuration form 130 controls the appearance of elements in the form. The user does not have to know in advance how to configure the selected activity because the editor associated with the activity's configuration form will guide the user. In the example shown in FIG. 1, the user has selected five activities. Invoke activity 120, Throw activity 130, and Empty activity 160 are sibling activities. Sibling activities share the same parent activity and are arranged in a single column on the computer display. In this embodiment, the parent activity of Invoke activity 120, Throw activity 130, and Empty activity 160 is viewable by scrolling to the left. Flow activity 140 and Throw activity 150 are sibling activities that share parent activity Invoke 120. Because Flow activity 140 and Throw activity 150 are sibling activities, they are arranged in a single column to the right of their parent activity Invoke 120.

While various embodiments of a method enabling a user to design computer processes using a nonlinear workflow assembly environment for visual programming have been described above, it should be understood that they have been presented by way of example only, and not limitation. Thus, the breadth and scope of the invention should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

We claim:

1. A computer-implemented method for enabling a user to design a process, wherein the process is implemented in a visual programming language, the method comprising:
providing a user interface, wherein the user interface is displayed on a computer display screen;
displaying a menu through the user interface, wherein the menu comprises a plurality of user-selectable activities;
displaying a first configuration form through the user interface, wherein the first configuration form represents a first activity selected by the user, and wherein the first configuration form comprises at least one element necessary to configure the first activity;
providing a first editor associated with the first configuration form, wherein the first editor prompts the user to supply information associated with the at least one element necessary to configure the first activity;
displaying a second configuration form through the user interface, wherein the second configuration form represents a second activity selected by the user, wherein the second configuration form comprises at least one element necessary to configure the second activity, wherein the second activity comprises a sibling activity of the first activity, and wherein the first activity and the second activity are arranged in a first column on the computer display screen;
providing a second editor associated with the second configuration form, wherein the second editor prompts the user to supply information associated with the at least one element necessary to configure the second activity;
displaying a third configuration form through the user interface, wherein the third configuration form represents a third activity selected by the user, wherein the third configuration form comprises at least one element necessary to configure the third activity, and wherein the third activity comprises a first child activity of the first activity;
providing a third editor associated with the third configuration form, wherein the third editor prompts the user to supply information associated with the at least one element necessary to configure the third activity;
displaying a fourth configuration form through the user interface, wherein the fourth configuration form represents a fourth activity selected by the user, wherein the fourth configuration form comprises at least one element necessary to configure the fourth activity, wherein the fourth activity comprises a second child activity of the first activity, and wherein the third activity and the fourth activity are arranged in a second column to the right of the first column on the computer display screen;
providing a fourth editor associated with the fourth configuration form, wherein the fourth editor prompts the user to supply information associated with the at least one element necessary to configure the fourth activity.

2. A method according to claim 1, wherein the process comprises an automated business process.
